(19) United States
(12) Patent Application Publication
(10) Pub. No.: US 2009/0107907 A1
(43) Pub. Date: Apr. 30, 2009

(54) DROPLET-BASED DIGITAL MICRODIALYSIS

(75) Inventors: Cheng-fu Chen, Fairbanks, AK (US); Kelly L. Drew, Fairbanks, AK (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: UNIVERSITY OF ALASKA FAIRBANKS, Fairbanks, AK (US)

(21) Appl. No.: 11/923,528

(22) Filed: Oct. 24, 2007

(51) Int. Cl. B01D 61/56

(52) U.S. Cl. 210/321.71

(57) ABSTRACT

The invention relates to a droplet-based digital microdialysis method that utilizes discrete perfusate droplets marched through a microchannel in an intermittent manner. The droplets sequentially reside on a microdialysis membrane that is in contact with the test fluid, e.g., fluid in an extracellular space. The droplets remain stationary at the membrane site for a period of time for rapid equilibration with the test fluid, and is then marched to an outlet port for processing. The invention further relates to microdialysis probes and methods based on the droplet-based digital microdialysis.

### FIELD OF THE INVENTION

The invention relates to microdialysis methods and microdialysis probes and devices.

### BACKGROUND OF THE INVENTION

Microdialysis is an invasive membrane-sampling technique in which a probe is inserted into tissue in vivo, such that one side of a porous or semi-permeable microdialysis membrane is in contact with extracellular fluid and the other side is flushed or rinsed with a dialysis fluid (perfusate) that takes-up substances from the extra cellular fluid through the membrane. Microdialysis selectively samples molecules from the extracellular fluid of tissue via a diffusion-based mechanism: only molecules of sizes smaller than that of the molecular weight cut-off of the microdialysis membrane can diffuse through the membrane to equilibrate with the perfusate. The analyte-laden liquid, often called dialysate, is rich in chemical information about the molecular activities taking place in the tissue.

Microdialysis is currently one of the best methods for sampling an extracellular fluid compartment and is applied in biological, pharmaceutical, and clinical studies. As one kind of catheter-type technique, microdialysis has a wide variety of applications such as biological sample cleanup, observing metabolic activity in tumors, brain and other tissues in humans, and monitoring neurotransmitters in the brain.

As an invasive technology, microdialysis has advantages over both other in vivo sensor technologies and non-invasive methods. Microdialysis has advantages over other in vivo sensor technologies such as electrochemical sensor technologies because it is often coupled with analytical separation techniques that simplify identification of analytes. Comparing to non-invasive methods such as positron emission tomography, the microdialysis technique is more cost-effective and can be applied in a subject without use of anesthetic.

Furthermore, the microdialysis technology has applications beyond the sampling of extracellular fluid. For example, microdialysis allows delivery of compounds into an extracellular space, and therefore, can be used to administer pharmacological agents for focused application to neural recording sites.

However, the application of the microdialysis technology has been limited by problems associated with conventional microdialysis probes. Microdialysis probe technology has changed little since 1966 when the original idea of microdialysis was first presented. Based on continuous flow for sampling, current microdialysis typically provides temporal and spatial resolution of about 600 seconds and 0.1 mm³, respectively. Problems associated with these probes include large (relatively) dead volumes, rough spatial resolution and traumatic tissue damage associated with probe implantation. Large cross-sectional areas cause significant tissue damage that can hamper interpretation of results. Poor spatial resolution due to relatively large probe size decreases ability to sample the desired functional pool. Prolonged temporal resolution, particularly, is a concern for glutamate detection because of the presumed rapid clearance and short diffusion distances associated with glutamatergic synapses.

A fluid can flow because there is a higher pressure head in its upstream. However, the back pressure can prevent the fluid from flowing farther. Usually the pressure head is three-fold: the hydraulic head (e.g., a hydraulic pressure source), the gravity head (e.g., the upstream is at a higher position like the water tower), and the velocity head (e.g., the flow coming out of the garden hose is always faster than before it hits the ground). A fluid flowing in a pipe exhibits a slower or even no velocity in the vicinity near the interior wall of the pipe. The drag force exerted by the roughness of the wall reduces the flow velocity, and in turn consumes the pressure head. This phenomenon is customarily called the frictional pressure drop in the literature of engineering discipline and the back pressure in the quantitative microdialysis literature.

The back pressure is one of the major concerns in conventional microdialysis. Recent work with small carbon fibers suggests that smaller probes may minimize traumatic tissue damage resulting from probe implantation. Micro-fabrication technologies now make it feasible to decrease dimensions of integrated microchannels and semipermeable surfaces to length scales on the order of 30-40 μm suggesting that microdialysis probes could be reduced to these dimensions, providing a channel flow areas on the order of 1,000 μm² or less. However, the high surface to volume ratio and the surface roughness of microchannels exaggerates the effect of the viscous force of fluid on its flowability at the micron scale, such that continuous flow through microchannels will be severely limited by back pressure at sufficiently small sizes.

In microdialysis, the recovery, i.e., the percentage of specific substances obtained in the perfusate as compared to the true value in the extracellular fluid, depends on various factors such as the perfusion flow rate. Conventional microdialysis operates at flow rates that do not allow for dialysate equilibrating with the extracellular fluid, a key factor that impacts attempts to quantify analytes in vivo. Interpretation of microdialysis results is typically based on proportional changes in analyte where flow rate affects relative recovery, the ratio of dialysate over theoretical extracellular concentrations. Relative recovery, however, can be influenced by fluctuations in flow rate, pharmacological treatments and temperature. The relative recovery increases as the flow rate decreases such that recovery is 100% when flow rate is zero.

Use of very low flow rates, extrapolation to zero flow and other techniques such as the zero-net-flux method allow the estimation of actual extracellular concentrations of analyte. However, in the case of the zero-net-flux method, calibration often loses its precision over time and requires re-calibration which interrupts continuous sampling. In the case of very low, “quantitative” flow rates, the ability to detect rapid changes in extracellular concentrations of analyte is compromised because of time required for analyte to equilibrate with large internal volume of conventional microdialysis probes. As the probe is decreased in size to reduce dead volume, viscous force between the perfusate and the rough surface of the channel wall becomes significant and makes precise fluid-control more difficult. Therefore, viscous drag and related issues may preclude running miniaturized microdialysis in the conventional manner.

Although microfluidic flow can reach steady state conditions quickly, a pulse-like flow can rise due to the inherent nature of syringe pump systems. Maintaining a continuous pressure-driven flow becomes more challenging as the channel dimensions get smaller, and inevitably the back pressure will hinder flow control especially when the channel is connected to a capillary for capillary electrophoresis.

Given the limitations associated with conventional microdialysis, there is a need for microdialysis technology that circumvents the limitations of continuous flow in microchannels of miniaturized probes and improves temporal and spatial resolution.

### SUMMARY OF THE INVENTION

In one aspect, the present invention provides methods for microdialysis.

In one embodiment, the method comprises,
(a) providing a microchannel having a microdialysis membrane in contact with an extracellular liquid;
(b) moving a first liquid droplet along the microchannel to the microdialysis membrane;
(c) allowing the first liquid droplet to reside at the microdialysis membrane for a period of time to permit the diffusion between the extracellular fluid and the first liquid droplet through the microdialysis membrane;
(d) removing the first liquid droplet off the microdialysis membrane;
(e) moving a second liquid droplet along the microchannel to the microdialysis membrane, wherein the second liquid droplet is separated from the first liquid droplet by a separator fluid;
(f) allowing the second liquid droplet to reside at the microdialysis membrane for a period of time to permit the diffusion between the extracellular fluid and the second liquid droplet through the microdialysis membrane; and
(g) removing the second liquid off the microdialysis membrane.

In another aspect, the present invention provides methods for forming and manipulating a liquid droplet in a microchannel.

In one embodiment, the method of the present invention comprises,

(a) forming a perfusate column by driving perfusate with capillary force from a reservoir to fill a portion of a microchannel, wherein the microchannel has a first end, a second end distal to the first end, a U-turn site between the first end and the second end, and an aperture locating at the U-turn site, wherein the aperture is covered with a microdialysis membrane;

(b) applying a first pressure to inject an air plug into the perfusate column;

(c) breaking the perfusate column to form a perfusate droplet;

(d) applying a second pressure to push the perfusate droplet toward the aperture covered with the microdialysis membrane;

(d) removing the second pressure to allow the liquid droplet to reside at the microdialysis membrane for a period of time; and

(e) removing the perfusate droplet off the microdialysis membrane.

In one embodiment, the method for manipulating a liquid droplet in a microchannel in the present invention comprises,

(a) presenting a hydrophilic liquid droplet in a microchannel, wherein
(i) the microchannel has a dielectric and hydrophobic inner surface; and
(ii) the microchannel consists of a plurality of segments, each segment has a first end and a second end distal from the first end, the diameter of the first end is smaller than the diameter of the second end, and the segments are connected to each other by connecting the second end of a first segment to the first end of a second segment;

(b) moving the liquid droplet from the first end of the first segment to the second end of the first segment by the interaction between the hydrophilic liquid droplet and the hydrophobic inner surface of the microchannel; and

(c) applying an electric filed at the first end of the second segment to generate an electrowetting effect, wherein the surface tension of the liquid is lowered to allow liquid droplet to pass the first end of the second segment.

In another aspect, the present invention provides microdialysis probes.

In one embodiment, the microdialysis probe comprises,

(a) a flow-through and U-turned microchannel having a first end, a second end distal to the first end, and a U-turn site between the first end and the second end, wherein the microchannel has a flow area on the order of about 1,000 μm²;

(b) a perfusate reservoir and a first pressure source connected to the first end;

(b) a nozzle and a second pressure source connected to the second end; and

(c) an aperture located at the U-turn site, wherein the aperture is covered with a microdialysis membrane;

In one embodiment, the microdialysis probe of the present invention comprises,

(a) a flow-through and U-turned microchannel having a first end, a second end distal to the first end, and a U-turn site between the first end and the second end, wherein an array of electrodes are embedded along the microchannel to provide electrical control of electrowetting energy;

(b) a perfusate reservoir connected to the first end;

(c) a nozzle connected to the second end; and

(d) an aperture located at the U-turn site, wherein the aperture is coved by a microdialysis membrane.

In one embodiment, the microchannel of the microdialysis probe has a dielectric and hydrophobic inner surface and a plurality of periodic narrowing inside.

In another aspect, the present invention provides digital microdialysis devices.

In one embodiment, the device for digital microdialysis comprises, a fluid reservoir containing perfusate;

an elongated probe having a microchannel having a microdialysis membrane aperture;

means for forming a plurality of discrete droplets of the perfusate from the fluid reservoir; and

means for moving one of the discrete droplets to the microdialysis membrane aperture, retaining the moved droplet at the microdialysis membrane aperture for a predetermined period, and removing the moved droplet from the microdialysis membrane aperture.

In one embodiment, the digital microdialysis of the present invention can be integrated with other analytical methods, such as capillary electrophoresis and electrochemical sensors in which on chip separation and detection of the sample volume is compatible with the dialysate droplet produced by the devices in the present invention.

In one embodiment, the device for digital microdialysis comprises,

(a) a microchannel having a first end and a second end distal to the second end;

(b) a first window located at the first end, wherein the first window is in connection with a nozzle and a first pressure source, and wherein the first pressure source is capable of generating both positive and negative pressure;

(c) a second window at the second end serving as a sampling chamber; and

(d) a third window located between the first end and the second end, wherein the third window is in connection with a reservoir and a second pressure source.

In one embodiment, the device for digital microdialysis in the present invention comprises,

(a) a microchannel having a first end and a second end distal to the first end, wherein
(i) the microchannel has a dielectric and hydrophobic inner surface and a linear array of diverging passageways; and
(ii) an array of electrodes are embedded along the microchannel to provide electrical control of electrowetting energy;

(b) a perfusate reservoir connected to the first end;

(c) a nozzle connected to the second end; and

(d) a window located between the first end and the second end of the microchannel serving as a sampling chamber.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A, 1B and 1C illustrate the operation principle of the microdialysis methods provided in the present invention. FIG. 1A shows a droplet of perfusate entering a microchannel; FIG. 1B shows the droplet of perfusate disposed on a microdialysis membrane for a period of time; and FIG. 1C shows the droplet moved to an outlet for chemical analysis;

FIG. 2 shows a two dimensional model for analyzing microdialysis, including an extracellular space, a sandwich-like microdialysis membrane, and a probe chamber;

FIGS. 3A and 3B are histograms showing analyte concentration at different times calculated using the model of FIG. 2;

FIGS. 4A, 4B, 4C and 4D illustrate the operation principle of the hydrophobic microdialysis vent method to form a metered droplet;

FIG. 5 illustrates a design that allows one droplet in the microchannel at one time by extending the HMCV principle to operate a push-hold-pull process;

FIG. 6A shows a plan view of a microdialysis-on-a-chip based on a push-pull-hold process;

FIG. 6B is a cross-sectional side view of the microdialysis-on-a-chip shown in FIG. 6A;

FIG. 6C shows the test fluid reservoir plate for the microdialysis-on-a-chip shown in FIG. 6A;

FIG. 6D is a plan view of a microdialysis probe device using the principles of the microdialysis-on-a-chip shown in FIG. 6A;

FIG. 6E is a cross-sectional end view of the of the probe portion of the device shown in FIG. 6D;

FIG. 6F is a cross-sectional end view similar to FIG. 6E, but for an alternative probe portion having a U-shaped microchannel;

FIG. 6G is a close-up of a portion of the device shown in FIG. 6A;

FIGS. 7A and 7B illustrate the principle of electrowetting;

FIGS. 8A-8D schematically illustrate the manipulation of a liquid droplet in a microchannel taking advantage of the hydrophobic characteristics of the microchannel by using a microchannel with a non-uniform geometry;

FIG. 9A is a plan view of an alternative microdialysis-on-a-chip using the principal of electrowetting and non-uniform geometry;

FIG. 9B is a cross-sectional side view of the microdialysis-on-a-chip shown in FIG. 9A;

FIG. 10A is a plan view of a microdialysis probe device using the principles of the microdialysis-on-a-chip shown in FIGS. 9A and 9B;

FIG. 10B is a close-up view of the probe portion of the device shown in FIG. 10A;

FIG. 10C is a cross-sectional end view of the probe portion of the device shown in FIG. 10A; and

FIG. 11 graphically illustrates a 0.5 nL droplet's transient states during equilibrating process.

### DETAILED DESCRIPTION OF THE INVENTION

The present invention provides microdialysis methods, probes and devices using discrete perfusate droplets for perfusion of a microchannel.

Nomenclature

c concentration of particles (L⁻³)

D diffusion coefficient (L²T⁻¹)

H height of the probe chamber used in simulations (L)

p1, p2 pressure port number

\vec{q} flux of particles in motion (L⁻²T⁻¹)

t time (T)

\vec{v} flow velocity (LT⁻¹)

v1, v2 HMCV valve number

W1, W2, W3 dimensions of the problem domain for simulations (L)

W width of channel (L)

w width of differential channel used in pneumatic control (L)

θ contact angle of droplet to microchannel (°)

σ surface tension (mT⁻²)

In one aspect, the present invention provides methods for microdialysis.

The digital microdialysis method of the present invention replaces continuous perfusate flow used in conventional microdialysis with a marching-type flow of the perfusate wherein a series of droplets are intermittently moved through a microchannel. As used therein, the qualifier “digital” generally refers to a method wherein discrete analyte-laden droplets are moved within a microchannel, such that the droplets engage the microdialysis membrane sequentially.

In one embodiment, the method comprises, (a) providing a microchannel having a microdialysis membrane in contact with an extracellular liquid; (b) moving a first liquid droplet along the microchannel to the microdialysis membrane; (c) allowing the first liquid droplet to reside at the microdialysis membrane for a period of time to permit diffusion between the extracellular fluid and the first liquid droplet through the microdialysis membrane; (d) moving the first liquid droplet off the microdialysis membrane; (e) moving a second liquid droplet along the microchannel to the microdialysis membrane, wherein the second liquid droplet is separated from the first liquid droplet by a separator fluid; (f) allowing the second liquid droplet to reside at the microdialysis membrane for a period of time to permit diffusion between the extracellular fluid and the second liquid droplet through the microdialysis membrane; and (g) moving the second liquid off the microdialysis membrane.

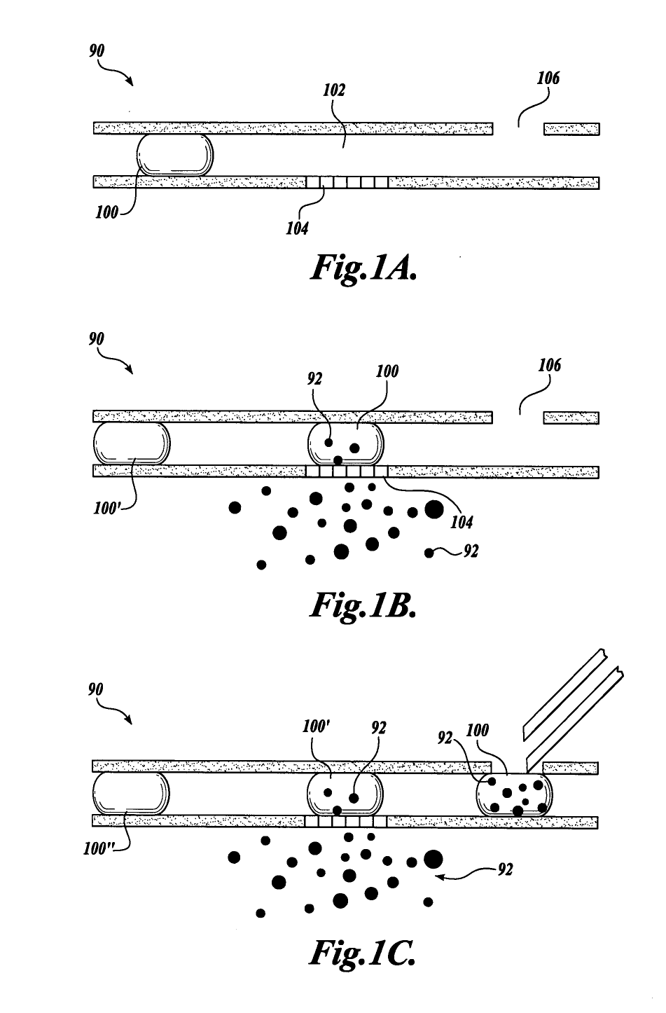

The operation principle of digital microdialysis methods described herein is illustrated in FIGS. 1A-1C, which present a sequence as a perfusate droplet 100 is moved through a simplified probe 90 that may be positioned to engage, for example, extracellular fluid including an analyte 92. In FIG. 1A a first droplet 100 enters a microchannel 102. In FIG. 1B the first droplet 100 is stepped forward to overlie a membrane 104, and a second droplet 100′ enters the microchannel 102. The first droplet 100 resides at the membrane 104 for a predetermined period of time, allowing analyte 92 from the extracellular fluid to diffuse across the membrane 104. The droplet 100 with analyte is then stepped forward away from the membrane 104, the second droplet 100′ is positioned at the membrane 104, and a third droplet 100″ enters the microchannel 102. The analyte-laden droplets proceed sequentially to an outlet port 106 for chemical analysis.

The perfusate droplets 100 must therefore be produced, conveyed, and positioned on the membrane 104 to at least partially equilibrate with the extracellular fluid. Because each droplet 100 resides on the membrane 104 for a certain amount of time and the duration of residence determines the equilibration level of analyte in a droplet, the digital microdialysis system operates substantially independently from a flow rate control, and therefore, avoids the back pressure and pulse-like flow problems associated with conventional continuous-flow microdialysis methods.

In addition, with a high marching rate of droplets, as opposed to the flow rate of a continuous fluid, digital microdialysis has a potential to achieve a fast sampling rate and more consistent relative recovery in comparison to the conventional methods. By adjusting the droplet residence times on the membrane according to the size of the droplet, the present method enhances the feasibility of achieving nearly 100% recovery in each droplet.

In one embodiment, individual droplets are separated by air at ambient pressure.

It is contemplated that the size of the liquid droplets may be optimized for particular applications. In general, the droplet volume may be determined by the cross-sectional area of the microchannel and the effective length of the membrane of the device. TABLE 1 lists representative droplet sizes that are presently considered suitable for digital microdialysis, and is intended to be exemplary rather than limiting.

TABLE 1
Representative devices and droplet volumes.

| C/S area of | Effective length | |
|---|---|---|
| microchannel flow | of membrane | Droplet volume |
| passage (μm²) | (μm) | (nL) |
| 5,000 (e.g., 100 × 50) | 200 | 1.00 |
| 5,000 (e.g., 100 × 50) | 100 | 0.50 |
| 2,500 (e.g., 50 × 50) | 200 | 0.50 |
| 2,500 (e.g., 50 × 50) | 100 | 0.25 |
| 400 (e.g., 20 × 20) | 200 | 0.04 |
| 100 (e.g., 10 × 10) | 100 | 0.01 |

In one embodiment, the first and second liquid droplets are approximately nanoliter or sub-nanoliter droplets, such that equilibration times are short.

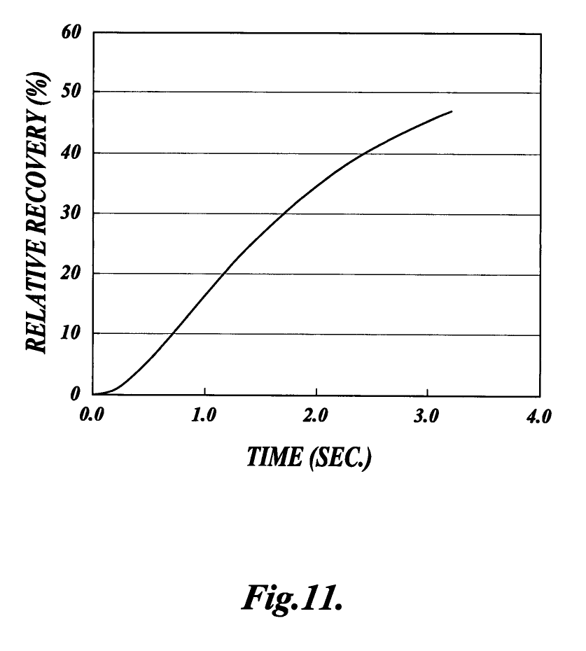

The optimal period of time that liquid droplets reside at the microdialysis membrane (i.e., the residence time) depends on the size of the liquid droplets. In general, the larger the size of the liquid droplet, the longer the residence time required for the liquid droplet to reach a desired equilibrium with the extracellular fluid. FIG. 11 illustrates a 0.5-nL droplet's transient states during equilibrating process. In this example, a 0.5 nL droplet must reside at the microdialysis membrane site for about 3 seconds to reach a 45% relative recovery.

Quantitative Digital Microdialysis—Equilibration Kinematics

To contrast the equilibration kinematics between conventional microdialysis (on a continuous flow base) and digital dialysis (on a stationary droplet base), a simplified model was developed that considers only the mechanistic aspect of particle transport. Without the loss of generality, the production/depletion of particles by the biochemical reactions such as metabolism, uptake, etc. have been deliberately excluded.

Specifically, microdialysis sampling in tissue is influenced by the journey of solute particles across the extracellular space (ECS), through the microdialysis membrane and into the chamber of the probe. In the ECS, the solute particles are subject to diffusion which is a motion mechanism driven by the existence of a concentration gradient of the particles (i.e., Fick's law); in the probe chamber, particles move under a combined diffusion and fluid drifting in which analyte particles diffuse in a “piggy-back” fashion relative to the movement of the carrying fluid, a phenomenon referred to as dispersion.

Modeling of the present invention starts with the description of the flux (the flow rate per unit area) of the particles encountered in dispersion:

\vec{q}=−D∇c+c\vec{v} (1)

where D is the diffusion coefficient of the particle of interest, c is the particle concentration, and \vec{v} is the flow velocity of the medium carrying the particles.

When applying Eq. (1) to the study of quantitative microdialysis, one must justify the usage of each term in this equation:

1. The magnitude of the diffusion coefficient D varies in an inhomogeneous porous-medium due to diffusion hindrance within the pore structure. On one hand, the influence of the pore structure on the change in the diffusion coefficient can be quantified by finding the associated torturosity factor. On the other hand, given a porous-medium structure such as the ECS in tissue such as brain, an effective diffusion coefficient can be calculated using the volume averaging method. (See, for example, O. A. Plumb, S. G. Oakes, R. Pope, J. C. Williams, Proceedings of the 26th Annual International Conference of the IEEE EMBS. San Francisco, 2004, p. 4045, the two-scale homogenization theory etc.; K. C. Chen, C. Nicholson, PNAS 97 (2000) 8306; and U. Hornung, Homogenization and Porous Media, Springer, N.Y., 1997.) The effective diffusion coefficient D depicts a somewhat macroscopic description of diffusion but it is still a local property, depending on the size of a representative volume element chosen from an inhomogeneous medium.

2. Eq. (1) can be simplified to Fick's law by dropping the c\vec{v} term from the right hand. It applies when no drifting factor exists in the problem domain of interest.

Then the Reynolds transport theorem is used to obtain the following governing equation for the particle transport:

$$\frac{\partial c}{\partial t} + ∇ \cdot ( c \vec{v} ) = ∇ \cdot ( D ∇ c ) \qquad ( 2 )$$

where ∇· is the divergence operator. It is noted that the diffusion coefficient D and the velocity \vec{v} are position-dependent and must be left inside the parentheses under the divergence operation.

To comparatively quantify the equilibration kinematics between conventional microdialysis and digital microdialysis, we tentatively assume a sampling situation for this comparison.

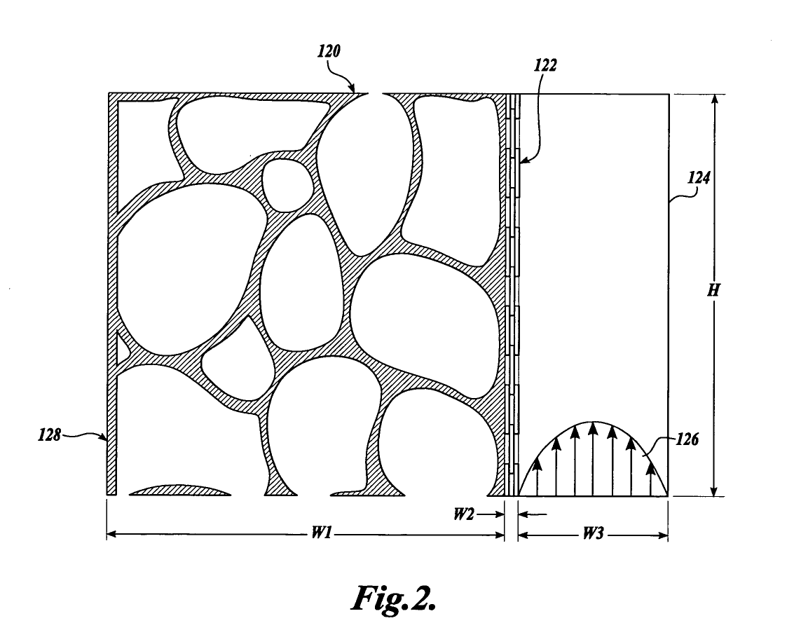

FIG. 2 shows a simple model domain for our calculations, including a two-dimensional description of three compartments: the ECS 120, a sandwich-like microdialysis membrane 122, and a probe chamber 124. Glutamate was used as the sample particle which has a diffusion coefficient of about 760 μm²/s in a bulky aqueous fluid. To ease the computational effort, the glutamate is modeled as a constant line source 128 where the concentration is kept at 100%. A sandwich-like membrane 122, which is commonly seen in photolithographic micro-fabrication, is used in the model. The membrane 122 has gaps about 30˜50 nm wide as diffusion passages. In the probe chamber 124, for the continuous-flow calculations the perfusate flow is modeled a Poiseuille flow which has a steady-state parabolic velocity profile 126. The probe chamber 124 is 50 μm (H)×10 μm (W3) and placed 10 μm away from the line source of glutamate 128.

The probe chamber 124 may be rectangular rather than circular as seen in some conventional microdialysis probes. The microdialysis membrane 122 may be formed from, for example, polyethersulfone, cuprophane, polycarbonate, polyamide, cellulose, or the like. A person skilled in the art would recognize that the porous microdialysis membrane may be made by the following representative methods:

Method 1: Stack the thin films of SiO₂ (or Si), TiO₂ (or Ti), and polyethylene oxide (PEG) to form a composite porous membrane. See, for example, Chang, H. Y.; Lin, C. W., “Proton conducting membranes based on PEG/SiO2 nanocomposites for direct methanol fuel cells,” Journal of Membrane Science, 218(12) (2003), p295-306; and Lin, C. W., Chang, H. Y., Thangamuthu, R., “Structure-property relationship in PEG/SiO2 based proton conducting hybrid membranes—A 29Si CP/MAS solid-state NMR study,” J. Membrane Science, available online 27 Nov. 2003.

Method 2: Directly sandwich a commercially available porous membrane during the fabrication process. Any suitable commercial porous membrane may be useful in the present invention, including but not limited to, polyamide hollow fiber membrane (MWCO=15 kDa, Millipore, Inc.), polycarbonate membrane (pore size is about 15˜100 nm, Whatman, Inc.), and cellulose membrane (Bel-Art Products, Inc.). The commercially available membrane can be bonded to a device of the invention by applying adequate pressure (e.g., 3 KPa) under an elevated temperature (e.g., 130° C.) to a SU-8 photoresist.

Method 3: Direct electron-beam process on the SiO₂ to produce the pores.

The simulation considers the effective diffusion coefficients of glutamate in the extracellular space (367 μm²/s) and in the microdialysis membrane (108 μm²/s). By mimicking the extracellular space in brains, in FIG. 2, the extracellular space has a volume fraction of about 20%. The reflective boundary condition was imposed to one side of the chamber region to consider that analytes are reflected inside from the probe wall and confined in the chamber. Two opposite edges of the membrane region (refer to FIG. 2 for locations) were set with a zero-concentration condition by assuming that the structure of the microdialysis membrane is impermeable to the solute particles such as glutamate. Other unspecified boundaries of the problem domain are free boundaries across which no constraint is imposed to effect the free transport phenomena modeled in Eq. (2).

The velocity along a streamline in the probe chamber is constant according to the model description addressed above. Therefore, the velocity term on the left hand of Eq. (2) can be independent of the divergence operator:

δc/δt−\vec{ν}·∇c=∇·(D∇c) (3)

The finite difference method was employed to implement Eq. (3) in the problem domain to calculate the distribution of the concentration in the ECS 120, membrane 122, and probe chamber 124.

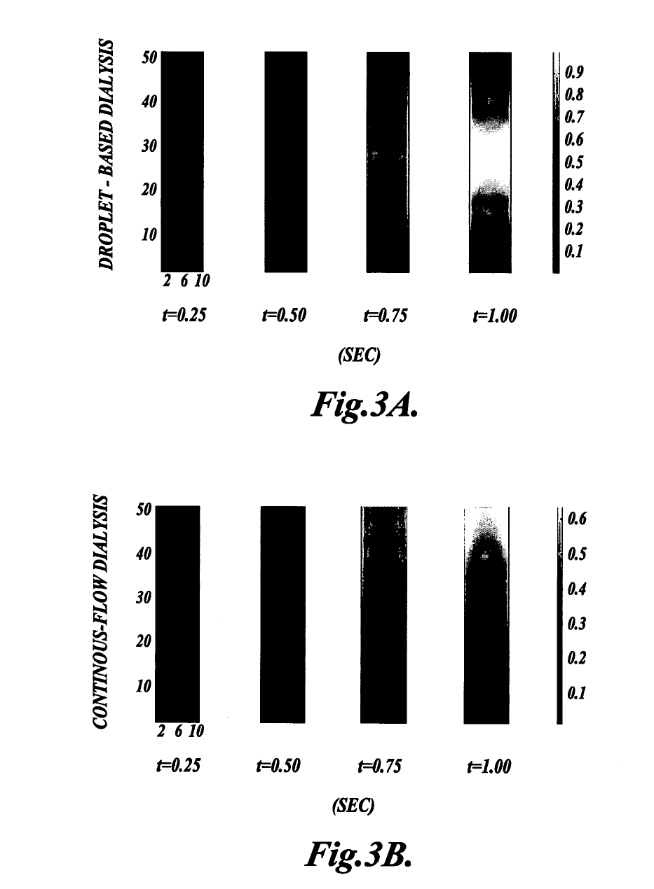

FIGS. 3A and 3B compare the histograms, in rectangular slots of the chamber domain 124, of the equilibration process for the proposed digital microdialysis (FIG. 3A) and conventional microdialysis (FIG. 3B). For the droplet-based digital microdialysis, the probe chamber 124 is initially filled with a perfusate liquid with zero concentration. The filled, rectangular perfusate was used to approximate a droplet sitting on the membrane for equilibration. The filled perfusate sits motionlessly in the chamber during the simulation time and is used to mimic the droplet residing on the membrane as designed. For the continuous-flow based perfusion, the Poiseuille flow with a constant volume rate of 20 nL/sec is used. The results shown in FIGS. 3A and 3B, not achieving their equilibrium conditions yet, contrast the equilibration kinetics and the concentration levels at different times. The droplet-based digital dialysis (FIG. 3B) produces a more uniform distribution and a higher concentration of analyte within a given time period. Other parametric studies have also been conducted such as changing the dimensions (W1, W2, W3, and H), and/or the volume rate of the Poiseuille flow (results not shown) and gained the following observations:

1. At any time, the concentration of analyte in a stationary droplet is higher than that of the perfusate flow in the same chamber. The difference in the concentration levels becomes less significant as the flow rate of the conventional microdialysis decreases, implying that analyte equilibrates between the two compartments.

2. The statement above is generally numerically true regardless of the distance between the probe and the source (W1) and/or the membrane thickness (W2). However, the larger the dimension in W1 and/or W2, the longer it takes analytes to equilibrate (since analytes take a longer journey, by diffusion, in the extracellular space and the membrane). If one only wishes to quantify the probe performance in vitro, then the corresponding instrumental response can be simulated by directly placing the line source of particles next to the left side of the probe chamber.

In another aspect, the present invention provides methods for forming and manipulating a liquid droplet in a microchannel.

Digital microdialysis requires formation of generally uniform, metered droplets. The liquid droplet useful in the present invention may be formed and manipulated, for example, by the “electrowetting on dielectric” method, the “hydrophobic microcapillary vent” (“HMCV”) method, and the oil-aided method that takes advantage of oil's hydrophobicity feature to shear off droplets from a continuous aqueous flow.

Pneumatic Driven Digital Microdialysis

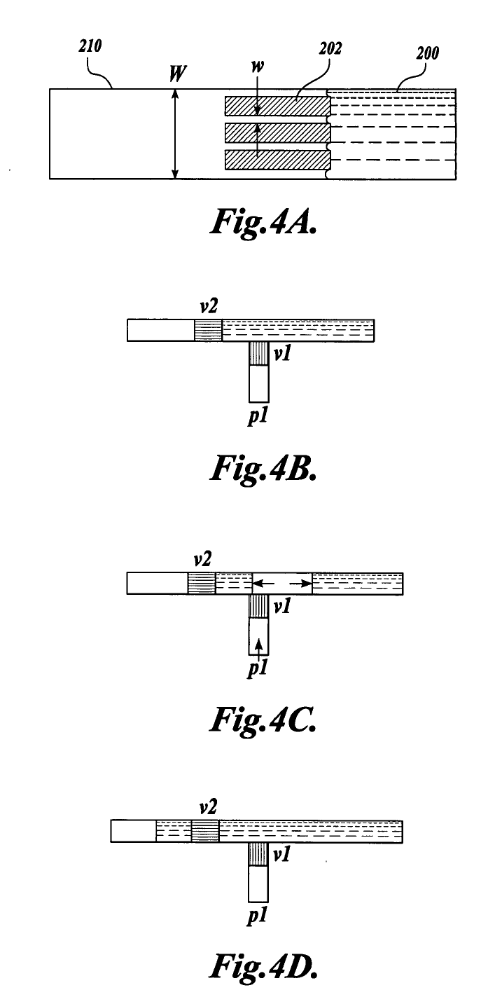

The operation principle of HMCV is illustrated in FIGS. 4A-4D. In essence, HMCV employs differential geometry in a hydrophobic microchannel 210 to form a gate with which to help form, meter, transport, and mix droplets or fluids as small as picoliters in size or smaller. (See, for example, Hosokawa, K., Fujii, T., and Endo, I. (1999) Handling of picoliter liquid samples in a poly(dimethylsiloxane)-based microfluidic device. Analytical Chemistry, 71, 4781-4785.) In this example a plurality of parallel barriers 202 are provided in the microchannel 210. The liquid 200 in the microchannel is stopped due to the geometry-change-induced pressure barrier which in this example is about 2σ cos θ(1/w−1/W) in magnitude, where u is the liquid's surface tension, θ the contact angle of the liquid to the microchannel, and w and W are shown in FIG. 4A. Consider an HMCV design using W=30 μm w=3 μm, θ=120°, and σ=0.073 N/m (water at room temperature), the pressure barrier can be up to 3.65 kPa which is the pressure needed to push a droplet through the differential gate. On the other hand, consider a droplet sitting on a hydrophobic porous membrane that has an averaged pore size of R=50 nm in radius, leakage would occur when the droplet is subjected to a pressure difference, according to the formula Δp=2y/R, of 1,500 kPa, almost 400 times larger than the pressure barrier. Furthermore, the surface roughness of the microchannel and/or the membrane also promotes hydrophobicity, making the droplet more difficult to leak through the microdialysis membrane. Therefore, leakage through the microdialysis membrane is unlikely to happen.

FIGS. 4B, 4C, and 4D schematically illustrate a sequence for an initial design process using HMCV to form a metered droplet. First, the capillary force drives the liquid to fill the microchannel and the liquid is stopped at v2 (FIG. 4B). A pneumatic pressure larger than the pressure barrier imposed by v2 is applied through port p1 to separate the liquid (FIG. 4C). The metered liquid passes through v2 to form a droplet, and releasing the pneumatic pressure from port p1 will let the liquid fill the microchannel again (FIG. 4D). Repeating this process will produce an array of separated droplets. Droplet volume can be precisely estimated by multiplying the cross-sectional area of the channel and the distance between v1 and v2. The droplet size can be varied via the distance between the two valves during fabrication.

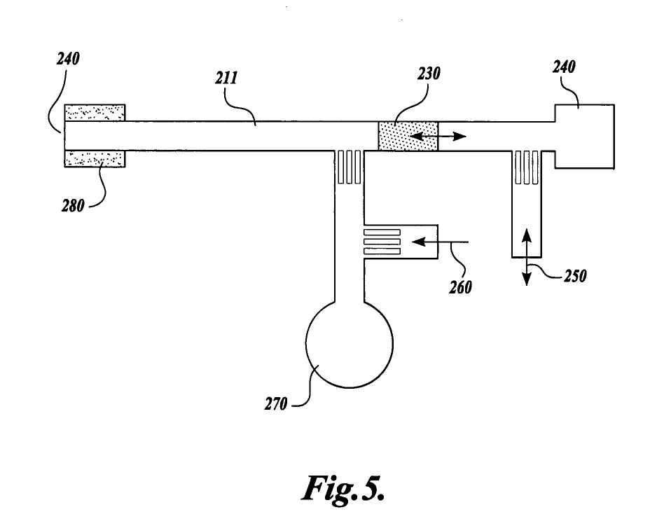

FIG. 5 illustrates a design that produces one droplet in a microchannel at a time by extending the HMCV principle to operate in what is herein referred to as a “push-hold-pull” process, because a metered droplet 230 is formed at one end of the microchannel 211, having a microdialysis membrane 280 disposed at the other end. The droplet 230 is pneumatically “pushed” toward the membrane 280 by applying a positive pressure at port 250 (maintaining the pressure at port 260 positive to deadlock the passage to a reservoir 270); the droplet 230 is maintained at the membrane for a period of time, then “pulled” back by applying a negative pressure at port 250, and guided to an outlet port 240. The outlet port 240 has an opening diameter wider than the height of the microchannel such that the pressure difference between both sides of the droplet will tend to “push” the droplet out of the nozzle 240 until no liquid remains inside the channel. This process can be repeated for intermittent sampling with a period determined by the push-hold-pull cycle.

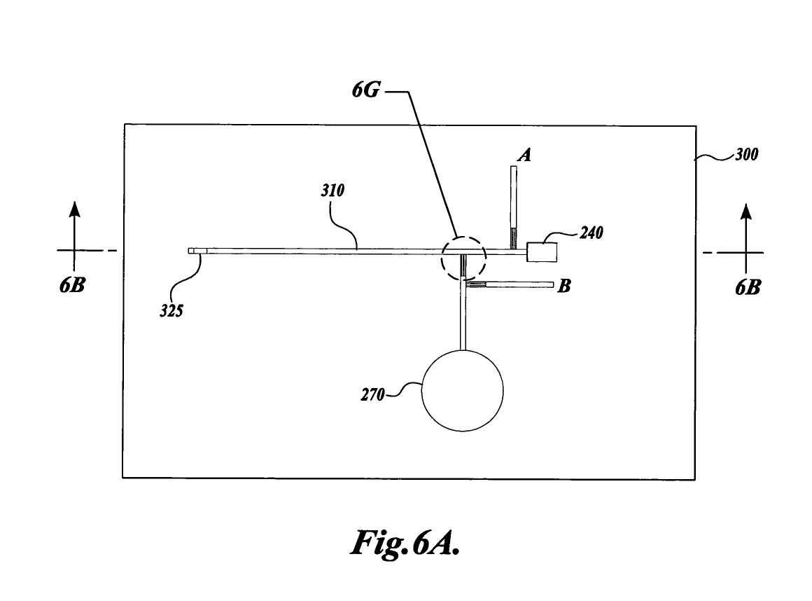

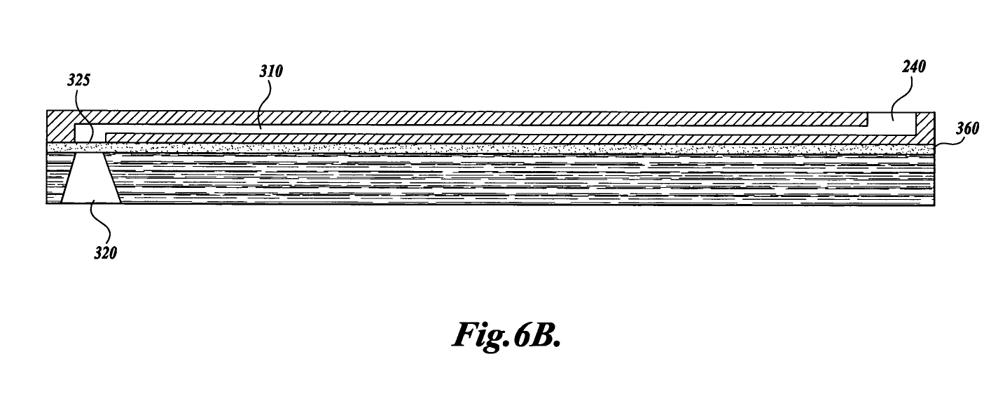

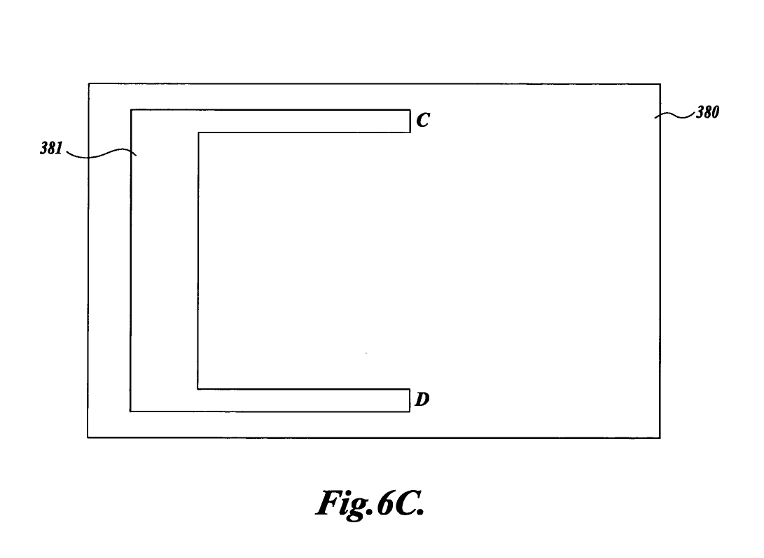

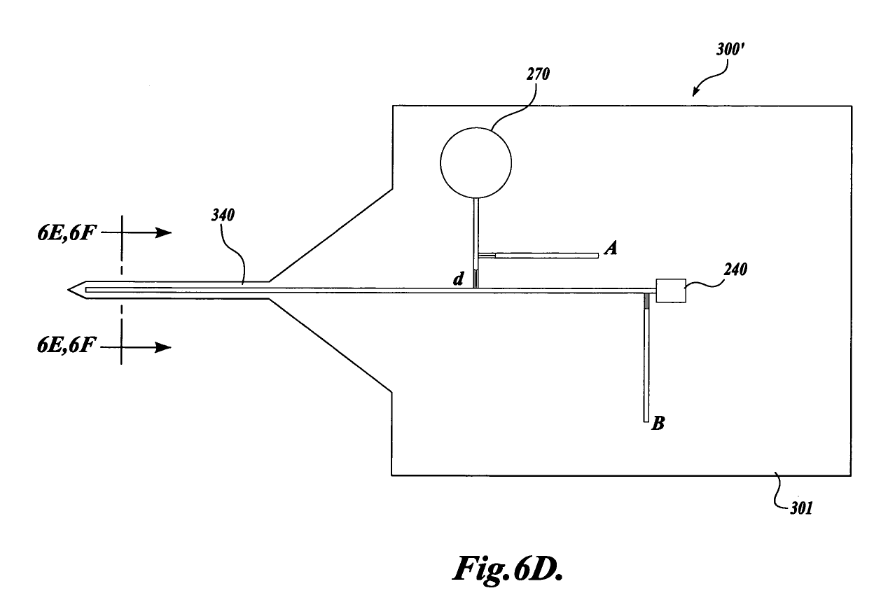

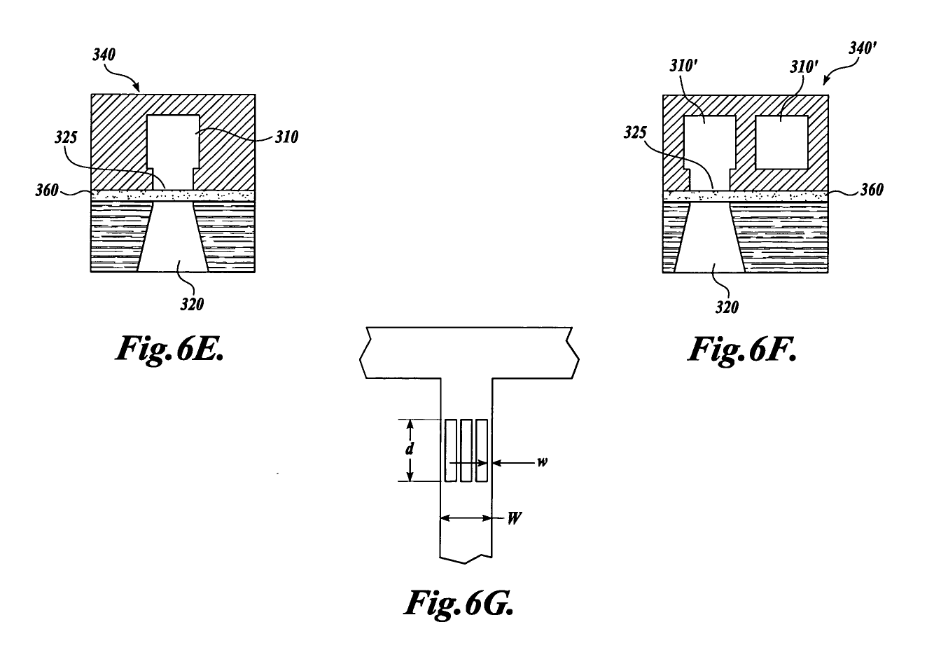

Based on the push-hold-pull process described above, a preliminary test apparatus for a digital microdialysis on a chip is shown in FIGS. 6A and 6B, wherein FIG. 6A is a plan view and FIG. 6B is a cross-sectional side view. This test apparatus comprises a digital microdialysis assembly 300 having a microchannel 310 with a distal window 325 covered by a membrane 360. For convenience in fabrication, the membrane 360 may underline the length of the microchannel 310. A sampling chamber 320 is provided below the window 325. The sampling chamber 320 in this test apparatus is open at the bottom and positioned to overlie a channel 381 containing a test fluid, as described below. For example, the microchannel 310 for the initial test apparatus may be approximately 50 μm×50 μm square in cross-section.

Ports located at A and B on the digital microdialysis assembly 300 are connected to external pressurized gas sources (not shown) to form and manipulate individual droplets using the push-hold-pull process described above from perfusate in the reservoir 270.

As shown in FIG. 6C, a test fluid reservoir plate 380 defines a larger channel 381 etched in the plate 380, through which a constant flow of glutamate solution will be pumped through an inlet port at C and outlet port at D, for example, to simulate a well-stirred in vitro testing environment. FIG. 6G shows a close-up of section G in FIG. 6A. It is contemplated that parametric prototypes may be produced by varying the dimensions, e.g., d, w and W in FIG. 6G. It is also contemplated that the test fluid channel 381 may alternatively be sized to hold a tissue slice underneath the microdialysis membrane 360 and window 325, with air vented through the slice, for testing.

FIG. 6D shows a preliminary design for a digital microdialysis device 300′ based on the test apparatus 300 described above. The device 300′ includes a digital microdialysis probe portion 340 having a length of about 10˜15 mm. The probe portion 340 is adapted to be inserted in tissue such as brain and other tissue for in vivo testing. The shank portion 301 is sized to accommodate the various other elements including the reservoir 270, the outlet port 240, etc.

FIG. 6E shows a cross-section of the probe portion 340 with a microchannel channel 310 defining a window 325 overlying the porous membrane 360, and the sampling chamber 320 which is open to the extracellular fluid. (For clarity in explaining the present apparatus, the FIGURES herein are not to scale.)

It will be readily apparent to persons of skill in the art that an alternative probe portion 340′ may be constructed to use one-way droplet marching by providing a U-shaped microchannel 310′ in the probe portion 340′. This alternative probe portion 340′ is illustrated in FIG. 6F, which is similar to FIG. 6E, but shows the cross-section of a probe portion 340′ wherein the microchannel 310′ includes a return portion.

Electrowetting Driven Digital Microdialysis

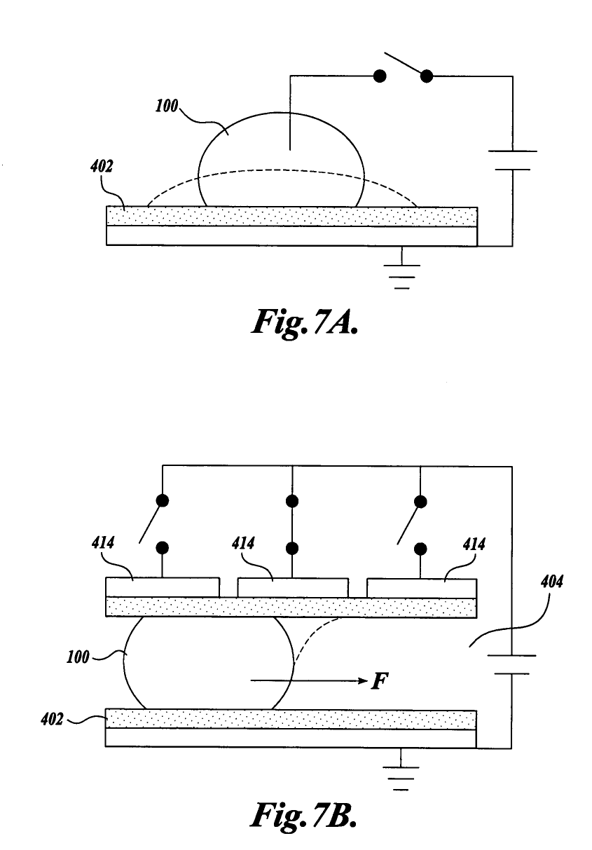

An alternative method for generating and manipulating individual droplets is electrowetting driven digital microdialysis. FIGS. 7A and 7B illustrate the principle of electrowetting. (See, Mugele, F. and Baret, J. -C. (2005) Electrowetting: from basics to applications, and J. Phys: Condens. Matter, 17, R705-R774.) When a droplet 100 is on a dielectric, hydrophobic surface 402 and charged, its shape becomes flatter, as indicated by the dashed line in FIG. 7A. This phenomenon can be used to generate a surface tension gradient wherein a partially charged, or asymmetrically charged, droplet 100 can be caused to move in a channel 404, as indicated by the arrow F in FIG. 7B. In particular, by suitably placing an array of electrodes 414 along the channel, and sequentially varying the electrical potential along the array of electrodes 414, the droplet 100 can be urged to move through the channel. This technique may be accomplished, for example, using a few tens of volts to drive a ˜100 nL droplet at a speed within the cm-s⁻¹ scale. For a digital dielectrophoresis system, the electrowetting method may be used to manipulate an array of droplets marching along the microchannels for sampling at a controllable marching rate.

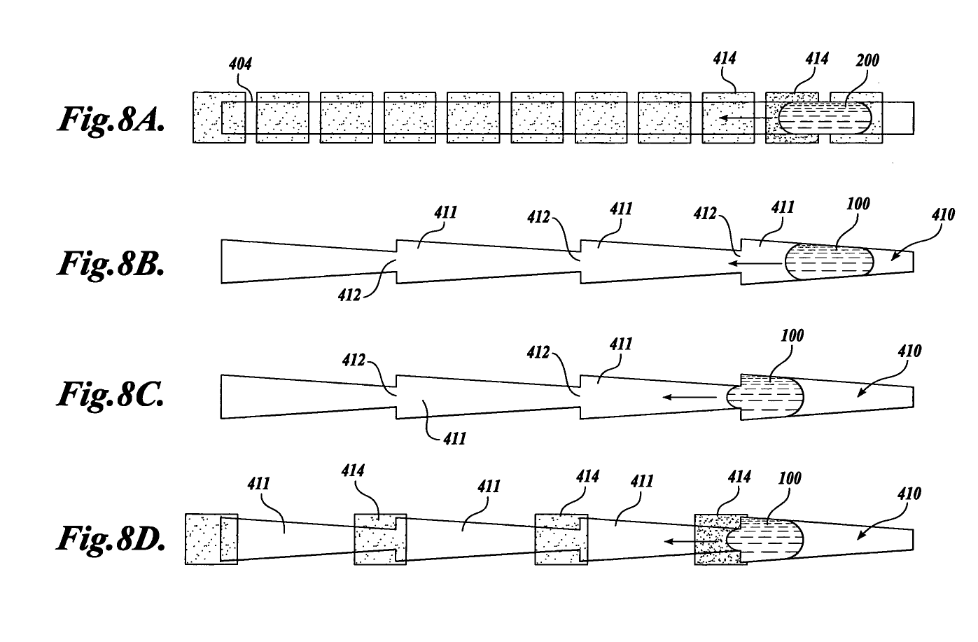

One design concern of electrowetting devices is the number of electrodes 414 required. To use electrowetting for moving a droplet 100, the droplet 100 must span or overlap at least two electrodes 414, as indicated in FIG. 8A. Therefore, for a microchannel with a size of 50 μm (W)×50 μm (H), to convey droplets for digital microdialysis, a 1 nL droplet would extend about 400 μm long in the microchannel, and to move the droplet 100 approximately 2 cm along the channel 404 would require at least about 50 electrodes 414. Of course a large number of electrodes 414 complicates fabrication as well as the control scheme for marching the droplets, and increases costs. Two options are contemplated to reduce the number of electrodes 414 required.

One option is to fabricate the microchannel 404 with a very small cross-sectional area. For example, if the channel cross-sectional area is reduced tenfold, a droplet of the same volume would be about ten times longer, and proportionately reducing the required number of electrodes 414. However, as the channel dimensions are reduced, the biased surface tension may not be large enough to mobilize the droplet.

Another option is to take advantage of the hydrophobic characteristics of a microchannel by using a microchannel having a non-uniform cross-section in the run-through direction as shown in FIGS. 8B, 8C, and 8D. As seen in FIG. 8B, a microchannel 410 is formed having a regularly varying longitudinal profile defining diverging portions 411 separated by throats or gates 412. In principle, a droplet 100 in a diverging portion 411 of the hydrophobic microchannel 410 will move toward the “wide” side to reduce the surface tension energy of the droplet 100. Accordingly, as shown in FIG. 8C the droplet 100 will then be stuck at the narrow gate 412 of the diverging portion 411. It is contemplated that a relatively small back pressure may be provided that tends to urge the droplet 100 from right to left in FIG. 8C, wherein the backpressure is not sufficient to overcome the resistance from the gate 412. As shown in FIG. 8D, electrodes 414 may be positioned at each gate 412 location. The electrode 414 may then be selectively energized to manipulate the droplet 100 surface tension at the gate 412, to permit the droplet 100 to pass therethrough. Combining this geometry method with the electrowetting method will reduce the number of electrodes 414 required in a digital microdialysis system of the present invention.

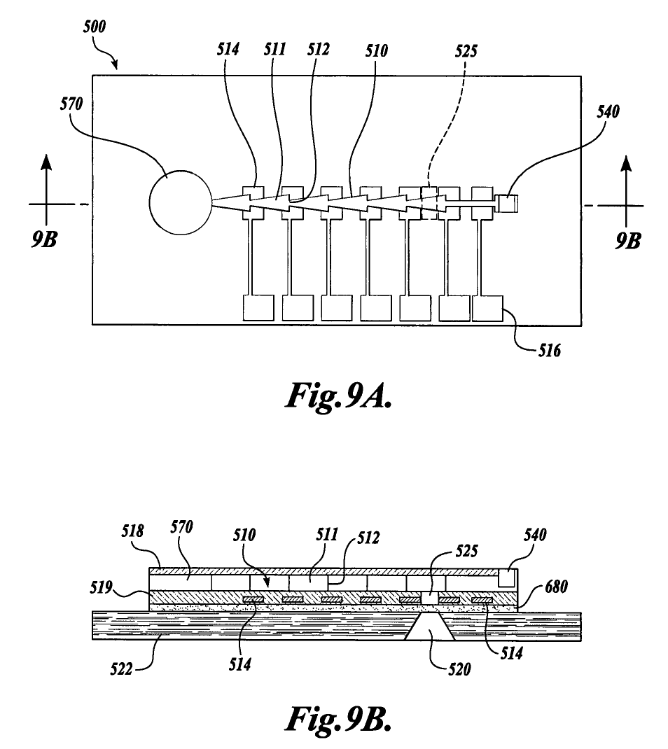

A plan view of a digital-microdialysis-on-a-chip 500 using the electrowetting and variable channel geometry concepts described above is shown in FIG. 9A. A reservoir 570 containing perfusate (which may include a pressurization port, not shown) is fluidly connected to a variable-geometry microchannel 510, similar to channel 410, described above. The channel 510 includes a number of diverging portions 511 with intermediate throats or gates 512. Electrodes 514 are positioned at each gate 512, and selectively energizable to drive droplets (not shown) through the microchannel 510 in a controlled manner. Metal pads 516 are provided for connecting to the electrodes 514. An outlet port 540 is disposed at the distal end of the microchannel 510 for receiving the droplets.

Refer now also to FIG. 9B, which shows a cross-section of the digital-microdialysis-on-a-chip 500 generally through section 9B. The upper and lower walls 518, 519 of the channel 510 are formed from a dielectric material. A window 525 is provided near the distal end of the channel 510, and a dielectrophoresis membrane 560 is disposed between the window 525 and a lower substrate 522. The lower substrate 522 includes a through channel defining a sampling chamber 520.

It will be appreciated that the chip 500 may be attached to the test fluid reservoir plate 380 shown in FIG. 6C, to provide digital microdialysis as described above. The flow of analyte solution in the test fluid reservoir plate 380 may be maintained at a constant speed to simulate a well-stirred in vitro testing environment. Perfusate droplets are produced from the reservoir 570 and sequentially driven along the microchannel 510 via a controlled electrical potential applied to each electrode 514. The electrical potential control between the electrodes 514 and the ground should be synchronized to produce and convey an array of droplets, one by one, to sit on the membrane 560 for equilibration, and then sequentially transport each droplet to the outlet port 540. Unlike the pneumatic driven design (FIGS. 6A-61), the electrowetting based design can allow multiple droplets to concurrently exist in the microchannel 510, a means to even improve the temporal resolution in sampling.

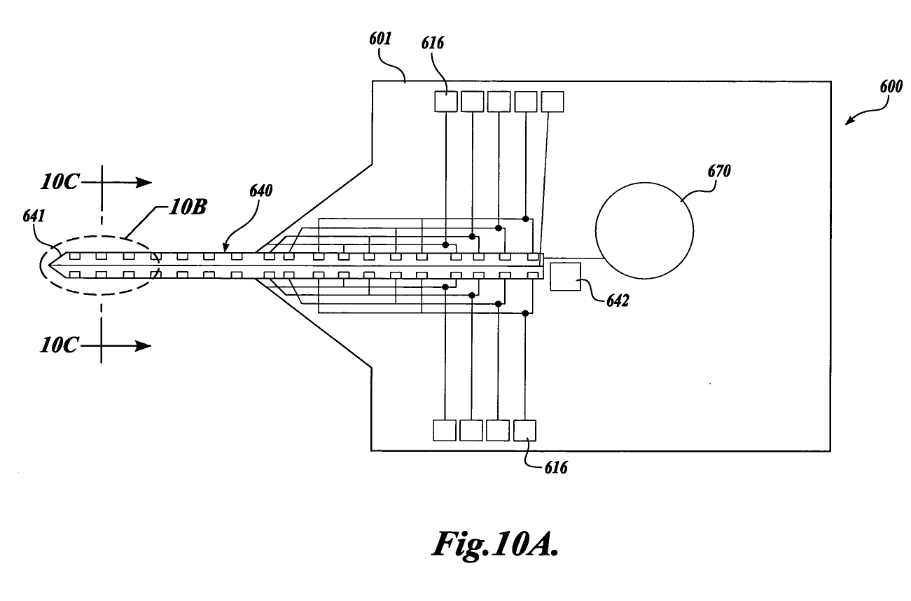

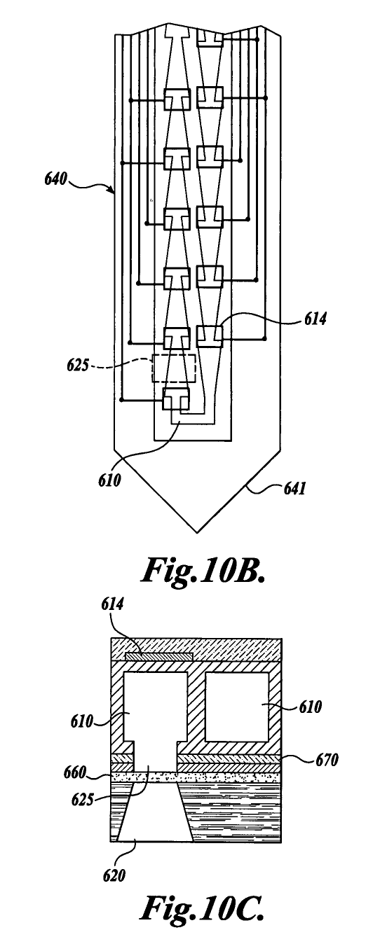

The chip 500 described above may be readily adapted to an electrowetting based digital microdialysis device 600, as shown in FIG. 10A. The single-piece device 600 comprises a square shank portion 601 (for example, about 4 cm²) and a probe portion 640 (for example, about 30˜50 μm wide×10˜15 mm long) that is adapted for implantation into tissue. The probe portion 640 may be sharpened at the tip 641. The shank portion 601 provides structural support to the device 600; and functions as an interconnection plate for microfluidic and electrical controls. Referring also to the close-up view of FIG. 10B, the probe portion 640 contains a flow-through, U-turned, hydrophobic microchannel 610. The microchannel 610 is fluidly connected to a perfusate reservoir 670, and to an outlet port 642, both defined in the shank portion 601. Electrodes 614 are provided, spaced along the length of the microchannel 610. A rectangular microdialysis membrane window 625 is disposed near the distal end of the microchannel 610.

Refer now also to FIG. 10C, which shows a cross-sectional view of the probe portion 640 through the window 625. A lower substrate 622 defines a sampling chamber 620 below the window 626, and a microdialysis membrane 660 is disposed therebetween. Perfusate droplets (not shown) from the reservoir 670 are marched through the microchannel 610, to the window 625 for diffusion with the ECS fluid, and returned to the outlet port 642. Connector sites defined by the metal pads 616 provide a mechanism for attaching controls for the electrodes 614.

It is optimistically predicted that a microdialysis probe about 5000 μm² in cross-section, or about one-tenth-fold of the existing smallest microdialysis probe, can be achieved. This probe may consist of a microchannel with a flow passage of 50 μm×50 μm in cross-section (which can be easily fabricated) with other structural/functional layers (the channel wall thickness, dielectric layer, etc.) The probe has a cross-section shown schematically in FIG. 10C, in which an array of electrodes 614 are embedded along the microchannels 610 to provide electrical control of electrowetting energy to convey droplets. 660 is the ground pad. 670 is the dielectric layer. However, because the rugged microchannels (FIG. 10C) may contribute to a larger probe cross-section, design and fabrication efforts are needed to keep the probe's cross-sectional area at a reasonably minimal value.

While the preferred embodiment of the invention has been illustrated and described, it will be appreciated that various changes can be made therein without departing from the spirit and scope of the invention.

1. A method for microdialysis, comprising,
(a) providing a microchannel having a microdialysis membrane that is adapted to be placed in contact with an extracellular liquid;
(b) moving a first liquid droplet along the microchannel to the microdialysis membrane;
(c) allowing the first liquid droplet to reside at the microdialysis membrane for a period of time to permit diffusion between the extracellular fluid and the first liquid droplet through the microdialysis membrane;
(d) removing the first liquid droplet off the microdialysis membrane;
(e) moving a second liquid droplet along the microchannel to the microdialysis membrane, wherein the second liquid droplet is separated from the first liquid droplet by a separator fluid;
(f) allowing the second liquid droplet to reside at the microdialysis membrane for a period of time to permit the diffusion between the extracellular fluid and the second liquid droplet through the microdialysis membrane; and
(g) removing the second liquid off the microdialysis membrane.

2. The method of claim 1, wherein the first and second liquid droplets are formed by an electrowetting on dielectric method.

3. The method of claim 1, wherein the first and second liquid droplets are formed by a hydrophobic microcapillary vent method.

4. The method of claim 1, wherein the first and second liquid droplets are formed by an oil-aided method.

5. The method of claim 1, wherein the first and second liquid droplets are sub-nanoliter droplets.

6. The method of claim 1, wherein the first and second liquid droplets are nanoliter droplets.

7. The method of claim 1, wherein the separator fluid is air at ambient pressure.

8. The method of claim 1, wherein the microdialysis membrane comprises one of polyethersulfone, cuprophane, and polycarbonate.

9. The method of claim 1, wherein the first liquid droplet resides at the microdialysis membrane site for about 3 seconds.

10. The method of claim 1, wherein the first liquid droplet resides at the microdialysis membrane site for about 2 second.

11. The method of claim 1, wherein the first and the second liquid droplets reside at the microdialysis membrane site from about 2 second to about 4 second.

12. The method of claim 1 further comprising the step of forming an array of liquid droplets inside the microchannel.

13. The method of claim 1, wherein the flow area of the microchannel is on the order of about 1,000 μm².

14-19. (canceled)
